(19) United States
(12) Patent Application Publication
(10) Pub. No.: US 2026/0058158 A1
(43) Pub. Date: Feb. 26, 2026

(54) ELECTRODE, BATTERY, AND METHOD FOR PRODUCING THE BATTERY

(71) Applicant: Panasonic Intellectual Property Management Co., Ltd., Osaka (JP)

(72) Inventors: HIROKI KAMITAKE, Osaka (JP); TATSUYA OSHIMA, Osaka (JP); TAKAAKI TAMURA, Osaka (JP); KAZUHIRO MORIOKA, Osaka (JP); SEIJI NISHIYAMA, Osaka (JP)

(21) Appl. No.: 19/373,238

(22) Filed: Oct. 29, 2025

Related U.S. Application Data
(63) Continuation of application No. PCT/JP2024/006945, filed on Feb. 27, 2024.

(30) Foreign Application Priority Data
May 9, 2023 (JP) 2023-077409

(51) Int. Cl. H01M 4/62; H01M 4/02; H01M 4/04; H01M 10/0562

(52) U.S. Cl. CPC H01M 4/625; H01M 4/0404; H01M 10/0562; H01M 2004/027; H01M 2004/028

(57) ABSTRACT

An electrode of the present disclosure includes a support and an active material layer that contains an active material, a solid electrolyte, and a carbon-based conductive additive and that has a first main surface not in contact with the support and a second main surface in contact with the support, in which a carbon atom concentration of a surface layer portion of the active material layer at the first main surface is greater than 29.8 at %.

### BACKGROUND

### 1. Technical Field

The present disclosure relates to an electrode, a battery, and a method for producing the battery.

### 2. Description of the Related Art

Japanese Unexamined Patent Application Publication No. 2021-044195 discloses a negative electrode that includes a current collector and an active material layer in contact with at least one surface of the current collector. The active material layer includes aggregates of some of active materials or some of conductive additives.

### SUMMARY

In the related art, it is desirable to improve the discharge capacity retention rate of the battery.

In one general aspect, the techniques disclosed here feature an electrode that includes a support and an active material layer that contains an active material, a solid electrolyte, and a carbon-based conductive additive and that has a first main surface not in contact with the support and a second main surface in contact with the support, in which a carbon atom concentration of a surface layer portion of the active material at the first main surface is greater than 29.8 at %.

According to the present disclosure, the discharge capacity retention rate of a battery can be improved.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross sectional view illustrating a schematic structure of an electrode according to a first embodiment;

FIG. 2 is a flowchart of a method for producing an electrode according to the first embodiment;

FIG. 3 illustrates step S3; and

FIG. 4 is a cross-sectional view illustrating a schematic structure of a battery according to a second embodiment.

### DETAILED DESCRIPTIONS

### Underlying Knowledge Forming Basis of the Present Disclosure

In order to improve electronic conductivity, a conductive additive is added to an electrode material containing an active material and a solid electrolyte. For example, when an active material layer is prepared by applying a slurry containing an electrode material to a current collector, the conductive additive that has aggregated settles down in the direction of gravitational force, and this sometimes leads to uneven distribution of the conductive additive inside the active material layer. When the distribution of the conductive additive is uneven, good electron conduction paths are not smoothly formed. As a result, the discharge capacity retention rate of the battery decreases.

The inventors of the present disclosure have conducted extensive studies to improve the discharge capacity retention rate of the battery. As a result, the inventors have conceived of the electrode of the present disclosure.

The embodiments of the present disclosure will now be described with reference to the drawings. The present disclosure is not limited to the embodiments below.

### First Embodiment

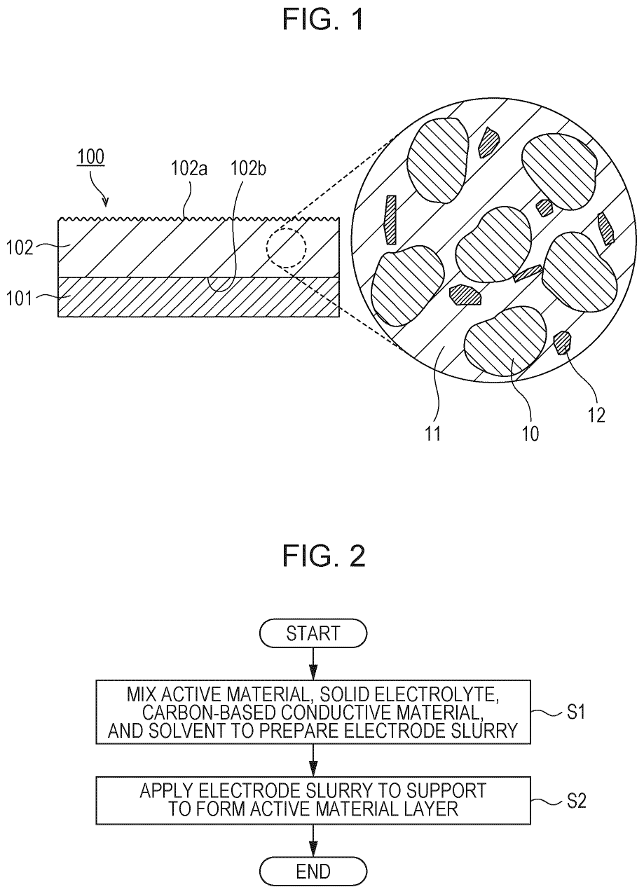

FIG. 1 is a cross-sectional view illustrating a schematic structure of electrode 100 according to a first embodiment.

The electrode 100 includes a support 101 and an active material layer 102. The active material layer 102 includes an active material 10, a solid electrolyte 11, and a carbon-based conductive additive 12. The active material layer 102 has a first main surface 102a not in contact with the support 101 and a second main surface 102b in contact with the support 101. A carbon atom concentration C₁ of a surface layer portion of the active material layer 102 at the first main surface 102a is greater than 29.8 at %. In FIG. 1, the first main surface 102a of the active material layer 102 is indicated by a wavy line to facilitate understanding. According to the electrode 100 of the first embodiment, good electron conduction paths can be formed in the active material layer 102. As a result, the discharge capacity retention rate of the battery can be improved.

The conductive additive often forms aggregates in the active material layer. When the aggregates are excessively large or the amount thereof is excessively large, the distribution of the conductive additive inside the active material layer may become uneven. Specifically, the conductive additive concentration increases from a front surface to a rear surface of the active material layer. When the distribution of the conductive additive is uneven, good electron conduction paths are not smoothly formed. As a result, the discharge capacity retention rate of the battery decreases.

The inventors of the present disclosure have conducted extensive studies and have found that the carbon atom concentration of a surface layer portion of an active material layer at a main surface not in contact with a support can reflect the dispersed state of the carbon-based conductive additive inside the active material layer. When the carbon atom concentration of the surface layer portion of the active material layer at the main surface not in contact with the support is sufficiently large, the carbon-based conductive additive disperses more evenly, and electron exchange of the active material present in the active material layer is facilitated. According to the electrode 100 of this embodiment, the carbon atom concentration C₁ of a surface layer portion of the active material layer 102 at the first main surface 102a not in contact with the support 101 is greater than 29.8 at %; thus, good electron conduction paths can be formed in the active material layer 102. As a result, the discharge capacity retention rate of the battery can be improved. Note that, in the present disclosure, the “surface layer portion of the active material layer 102 at the first main surface 102a” refers to a portion that includes the first main surface 102a and has a particular thickness that can be quantitatively analyzed by an elemental analysis method using an electron beam, such as energy-dispersive X-ray spectroscopy (EDS). The same applies to the “surface layer portion of the active material layer 102 at the second main surface 102b”.

The carbon atom concentration C₁ of the surface layer portion of the active material layer 102 at the first main surface 102a is determined by the following method by using a scanning electron microscope (SEM) and an energy-dispersive X-ray spectrometer (EDS). First, the first main surface 102a of the active material layer 102 is observed with the SEM (magnification: 1000×), elemental analysis is performed by the EDS, and the carbon atom concentration C in the desired measurement region is acquired. The area of the measurement region is, for example, 1.2×10⁴ μm². Next, the carbon atom concentration C is measured at multiple points (for example, five points) in the measurement region. The measured carbon atom concentrations C are averaged to determine the carbon atom concentration C₁ of the surface layer portion of the active material layer 102 at the first main surface 102a. The carbon atom concentration C₂ of a surface layer portion of the active material layer 102 at the second main surface 102b is determined in the same way. In order to evaluate the average state of the active material layer 102, the measurement region of the EDS is desirably sufficiently wide with respect to the median diameter of the active material 10 contained in the active material layer 102. For example, when the median diameter of the particles of the active material 10 contained in the active material layer 102 is represented by D (unit: μm), the area A of the measurement region desirably satisfies A≥(20D)². In the present disclosure, a median diameter refers to a particle diameter (d50) at which the accumulated volume is 50% in a volume-based particle size distribution. The volume-based particle size distribution is measured by, for example, a laser diffraction measurement instrument or an image analyzing instrument.

In order to increase the accuracy of the carbon atom concentration C measurement, elements that can be expected to be contained in the active material layer 102 must be selected as the elements to be measured by the EDS. Referring to the elements that can be contained in the active material layer 102 and major elements confirmed from the EDS spectrum, seven or more major elements are selected as the elements to be measured by the EDS. Here, carbon is to be included in the seven major elements. In other words, carbon and six or more major elements other than carbon are the subject of the measurement by the EDS. When there are fewer than six major elements other than carbon, elemental analysis is performed on each of the materials constituting the active material layer 102, and six or more elements are selected in the descending order of the element concentration in the entire active material layer 102. Examples of the measurement method used in the elemental analysis include inductively coupled plasma atomic emission spectroscopy (ICP-AES), inductively coupled plasma mass spectrometry (ICP-MS), X-ray photoelectron spectroscopy (XPS), and secondary ion mass spectrometry (SIMS). When there are still fewer than six major elements other than carbon despite the elemental analysis of each of the materials constituting the active material layer 102, only the elements detected by the elemental analysis may be the subject of the measurement by the EDS. After measuring these major elements, the carbon atom concentration C is calculated.

Here, the carbon atom concentration C₁ of the surface layer portion of the active material layer 102 at the first main surface 102a is often a value greater than the carbon atom concentration in the entire active material layer 102. This is presumably due to the phenomenon in which, for example, when the median diameter of the particles of the carbon-based conductive additive 12 is small with respect to other materials constituting the active material layer 102, the carbon-based conductive additive 12 tends to gather near the first main surface 102a of the active material layer 102. The same phenomenon may also occur when the specific gravities of materials other than the carbon-based conductive additive 12 constituting the first main surface 102a are large compared to that of the carbon-based conductive additive 12.

The carbon atom concentration C₁ of the surface layer portion of the active material layer 102 at the first main surface 102a may be greater than or equal to 30.0 at %. According to this feature, the discharge capacity retention rate of the battery can be further improved.

The carbon atom concentration C₁ of the surface layer portion of the active material layer 102 at the first main surface 102a may be greater than or equal to 40.0 at % or may be greater than or equal to 44.0 at %.

The carbon atom concentration C₁ of the surface layer portion of the active material layer 102 at the first main surface 102a may be less than or equal to 70.0 at %. When the carbon atom concentration C₁ is less than or equal to 70.0 at %, the carbon-based conductive additive 12 helps form ion conduction paths in the solid electrolyte 11. As a result, the inner resistance of the active material layer 102 can decrease. Thus, the battery can operate at a higher output.

The carbon atom concentration C₁ of the surface layer portion of the active material layer 102 at the first main surface 102a may be less than the carbon atom concentration C₂ of the surface layer portion of the active material layer 102 at the second main surface 102b. The carbon atom concentration C₂ maybe, for example, greater than or equal to 30.0 at %.

### Carbon-Based Conductive Additive

Examples of the carbon-based conductive additive 12 that can be used include graphites such as natural graphite and synthetic graphite, carbon blacks such as acetylene black and Ketjen black, conductive fibers such as carbon fibers, vapor-grown carbon fibers, carbon nanotubes, and carbon nanofibers, and conductive polymer compounds such as polyaniline, polypyrrole, and polythiophene. The carbon-based conductive additive 12 may contain any one of these materials or may contain at least two of these materials. The carbon-based conductive additive 12 may be composed of any one of these materials or may be composed of at least two of these materials.

The carbon-based conductive additive 12 may contain at least one selected from the group consisting of a fibrous carbon material and a granular carbon material.

According to this feature, the dispersibility of the carbon-based conductive additive 12 in the active material layer 102 is easily improved, and thus the discharge capacity retention rate of the battery can be further improved.

The carbon-based conductive additive 12 desirably contains a fibrous carbon material. According to this feature, the carbon-based conductive additive 12 further helps form ion conduction paths in the solid electrolyte 11. As a result, the inner resistance of the active material layer 102 can decrease further.

The fibrous carbon material may have an average fiber diameter less than or equal to 50 μm. According to this feature, the carbon-based conductive additive 12 is less likely to aggregate, and thus the dispersibility of the carbon-based conductive additive 12 in the active material layer 102 can be further improved.

The lower limit of the average diameter of the fibrous carbon material is not particularly limited. The lower limit of the average fiber diameter of the fibrous carbon material maybe, for example, 0.4 nm.

The fibrous carbon material may have an average length greater than or equal to 5 nm. According to this feature, the carbon-based conductive additive 12 is less likely to aggregate, and thus the dispersibility of the carbon-based conductive additive 12 in the active material layer 102 can be further improved.

The upper limit of the average length of the fibrous carbon material is not particularly limited. The upper limit of the average length of the fibrous carbon material maybe, for example, 500 μm.

The average fiber diameter and the average length of the fibrous carbon material are determined by the following method. First, the fibrous carbon material is separated from the active material layer 102 by using a solvent. Next, the fibrous carbon material (for example, five fibers) dispersed on a sample stage is observed with an SEM, and the fiber diameters and lengths are measured by image analysis or the like. The measured fiber diameters and lengths are respectively averaged to determine the average fiber diameter and the average length of the fibrous carbon material. When the fibrous carbon material is small, a transmission electron microscope (TEM) may be used in observation instead of the SEM to determine the average fiber diameter and the average length of the fibrous carbon material.

The granular carbon material may have a median diameter less than or equal to 100 nm. According to this feature, the dispersibility of the carbon-based conductive additive 12 in the active material layer 102 is easily improved.

The lower limit of the median diameter of the granular carbon material is not particularly limited. The lower limit of the median diameter of the granular carbon material may be, for example, 3 nm.

The carbon-based conductive additive 12 may be a mixture of a fibrous carbon material and a granular carbon material. For example, the carbon-based conductive additive 12 may be a mixture of a vapor-grown carbon fibers and acetylene black particles. By using a mixture of a fibrous carbon material and a granular carbon material, the cost can be cut while securing good electron conduction paths in the active material layer 102.

The median diameter of the carbon-based conductive additive 12 may be smaller than the median diameter of the active material 10. As a result, the active material 10 and the carbon-based conductive additive 12 can form a good dispersed state. As a result, the electronic conductivity in the active material layer 102 can be further improved.

### Solid Electrolyte

The solid electrolyte 11 may contain at least one selected from the group consisting of a halide solid electrolyte, a sulfide solid electrolyte, an oxide solid electrolyte, a polymeric solid electrolyte, and a complex hydride solid electrolyte.

The solid electrolyte 11 may contain at least one selected from the group consisting of a halide solid electrolyte and a sulfide solid electrolyte. According to this feature, the output density of the battery can be improved.

The solid electrolyte 11 may contain a halide solid electrolyte. The solid electrolyte 11 may be a halide solid electrolyte.

A halide solid electrolyte is, for example, represented by composition formula (1) below. In composition formula (1), α, β, and γ each independently represent a value greater than 0. M includes at least one element selected from the group consisting of metal elements other than Li and metalloid elements. X includes at least one selected from the group consisting of F, Cl, Br, and I.

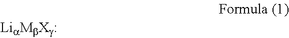

Metalloid elements include B, Si, Ge, As, Sb, and Te. Metal elements include all elements in groups 1 to 12 of the periodic table other than hydrogen and all elements in groups 13 to 16 of the periodic table other than B, Si, Ge, As, Sb, Te, C, N, P, O, S, and Se. In other words, metal elements are a group of elements that can be cations in forming inorganic compounds with halogen compounds.

Examples of the halide solid electrolyte that can be used include Li₃YX₆, Li₂MgX₄, Li₂FeX₄, Li(Al, Ga, In)X₄, Li₃(Al, Ga, In)X₆, and Li₃(Al, Ti)X₆ (X:F, Cl, Br, I).

In the present disclosure, when an element in a formula is expressed as “(Al, Ga, In)” or the like, this means at least one element selected from the group consisting of the elements inside the parentheses. In other words, (Al, Ga, In) means “at least one selected from the group consisting of Al, Ga, and In”. The same applies to other elements. A halide solid electrolyte exhibits excellent ion conductivity.

According to this feature, the output density of the battery can be improved. Furthermore, thermal stability of the battery is improved, and generation of toxic gas such as hydrogen sulfide is suppressed.

In composition formula (1), M may include yttrium (Y). In other words, the halide solid electrolyte may contain Y as a metal element.

The halide solid electrolyte containing Y may be a compound represented by composition formula (2) below.

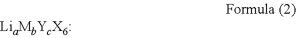

In composition formula (2), a+mb+3c=6 and c>0. In composition formula (2), M includes at least one element selected from the group consisting of metal elements other than Li and Y and metalloid elements. Here, m represents a valence of M. X includes at least one selected from the group consisting of F, Cl, Br, and I. M includes at least one selected from the group consisting of Mg, Ca, Sr, Ba, Zn, Sc, Al, Ga, Bi, Zr, Hf, Ti, Sn, Ta, and Nb.

Specific examples of the halide solid electrolyte containing Y that can be used include Li₃YF₆, Li₃YCl₆, Li₃ YBr₆, Li₃YI₆, Li₃YBrCl₃, Li₃YBr₃Cl₃, Li₃YBr₅Cl, Li₃YBr₅I, Li₃YBr₃I₃, Li₃YBrI₅, Li₃YClI₅, Li₃YCl₃I₃, Li₃YCl₅I, Li₃YBr₂Cl₂I₂, Li₃YBrCl₄I, Li_{2.7}Y_{1.1}Cl₆, Li_{2.5}Y_{0.5}Zr_{0.5}Cl₆, and Li_{2.5}Y_{0.3}Zr_{0.7}Cl₆.

According to this feature, the output density of the battery can be further improved.

The halide solid electrolyte may be a fluoride solid electrolyte. A fluoride solid electrolyte has high potential resistance, and thus, for example, the initial resistance of the battery is expected to decrease.

A fluoride solid electrolyte may have any composition as long as F is contained. A fluoride solid electrolyte may contain, for example, Li and F.

The fluoride solid electrolyte may be, for example, a compound represented by composition formula (3) below.

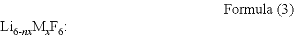

In composition formula (3), x satisfies 0<x<2. M is at least one selected from the group consisting of metalloid atoms and metal atoms other than Li. Here, n represents the oxidation number of M.

In composition formula (3), M may be composed of a single atom or multiple atoms. When M is multiple types of atoms, n represents the weighted average of the oxidation numbers of the individual atoms.

For example, when M includes Ti (oxidation number=+4) and Al (oxidation number=+3), the Ti-to-Al molar ratio is Ti/Al=3/7, and x=1, n is 3.3 from the formula “n=0.3×4+0.7×3”.

In composition formula (3), x may satisfy, for example, 0.1≤x≤1.9, 0.2≤x<1.8, 0.3≤x≤1.7, 0.4≤x≤1.6, 0.5≤x≤1.5, 0.6≤x≤1.4, 0.7≤x≤1.3, 0.8≤x≤1.2, or 0.9≤x≤1.1. M may include an atom having an oxidation number of +4, for example. M may include an atom having an oxidation number of +3, for example. M may include an atom having an oxidation number of +4 and an atom having an oxidation number of +3, for example.

In composition formula (3), M may include, for example, at least one selected from the group consisting of Ca, Mg, Al, Y, Ti, and Zr. M may include, for example, at least one selected from the group consisting of Al, Y, and Ti. M may include, for example, at least one selected from the group consisting of Al and Ti.

The fluoride solid electrolyte may be, for example, a compound represented by composition formula (4) below.

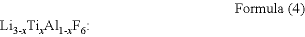

In composition formula (4), x may satisfy, for example, 0≤x≤1, 0.1≤x≤0.9, 0.2≤x≤0.8, 0.3≤x<0.7, or 0.4≤x<0.6.

The solid electrolyte 11 may contain a sulfide solid electrolyte. The solid electrolyte 11 may be a sulfide solid electrolyte.

A sulfide solid electrolyte can exhibit high ion conductivity. Thus, when the solid electrolyte 11 contains a sulfide solid electrolyte, the output density of the battery can be improved.

A sulfide solid electrolyte may have any composition as long as sulfur(S) is contained. A sulfide solid electrolyte may contain, for example, Li, P, and S. In addition, a sulfide solid electrolyte may further contain, for example, O, Ge, Si, etc.

A sulfide solid electrolyte may further contain, for example, a halogen etc.

A sulfide solid electrolyte may be, for example, of a glass ceramic type or of an argyrodite type. A sulfide solid electrolyte may contain, for example, at least one selected from the group consisting of LiI—LiBr—Li₃PS₄, Li₂S—SiS₂, LiI—Li₂S—SiS₂, Li₂S—B₂S₃, LiI—Li₂S—P₂S₅, LiI—Li₂O—Li₂S—P₂S₅, LiI—Li₂S—P₂O₅, LiI—Li₃PO₄—P₂S₅, Li₂S—GeS₂, Li₂S—GeS₂—P₂S₅, Li₂S—P₂S₅, Li₄P₂S₆, Li₂P₃S₁₁, and Li₃PS₄.

The sulfide solid electrolyte may be LiI—LiBr—Li₃PS₄. In the description below, “LiI—LiBr—Li₃PS₄” may be referred to as “LPS”.

According to this feature, the output density of the battery can be further improved.

The solid electrolyte 11 may contain an oxide solid electrolyte. The solid electrolyte 11 may be an oxide solid electrolyte.

Examples of the oxide solid electrolyte that can be used include NASICON solid electrolytes such as LiTi₂(PO₄)₃ and element-substituted products thereof, perovskite solid electrolytes based on (LaLi)TiO₃, LISICON solid electrolytes such as Li₁₄ZnGe₄O₁₆, Li₄SiO₄, LiGeO₄, and element-substituted products thereof, garnet solid electrolytes such as Li₇La₃Zr₂O₁₂ and element-substituted products thereof, Li₃N and H-substituted products thereof, Li₃PO₄ and N-substituted products thereof, and glass or glass ceramics in which a material such as Li₂SO₄ or Li₂CO₃ is added to a base material containing an Li—B—O compound such as LiBO₂ or Li₃BO₃.

The solid electrolyte 11 may contain a polymeric solid electrolyte. The solid electrolyte 11 may be a polymeric solid electrolyte.

Examples of the polymeric solid electrolyte that can be used include compounds formed between polymeric compounds and lithium salts. The polymeric compound may have an ethylene oxide structure. By having an ethylene oxide structure, a large amount of lithium salts can be contained, and the ion conductivity can be further increased. Examples of the lithium salts that can be used include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. As a lithium salt, one lithium salt selected from these can be used alone. Alternatively, as a lithium salt, a mixture of two or more lithium salts selected from these can be used.

The solid electrolyte 11 may contain a complex hydride solid electrolyte. The solid electrolyte 11 may be a complex hydride solid electrolyte.

Examples of the complex hydride solid electrolyte that can be used include LiBH₄—LiI and LiBH₄—P₂S₅.

The shape of the solid electrolyte 11 is not particularly limited. Examples of the shape of the solid electrolyte 11 include a needle shape, a spherical shape, and an elliptical shape. For example, the shape of the solid electrolyte 11 may be granular.

For example, when the shape of the solid electrolyte 11 is granular (for example, spherical), the median diameter may be greater than or equal to 0.01 μm and less than or equal to 100 μm. When the median diameter is greater than or equal to 0.01 μm, the contact interface between the particles of the solid electrolyte 11 does not excessively increase, and the increase in ion resistance in the electrode 100 can be suppressed. Thus, the battery can operate at a high output. When the median diameter is less than or equal to 100 μm, the active material 10 and the solid electrolyte 11 easily form a good dispersed state in the electrode 100. Thus, the battery capacity can be easily increased.

The median diameter of the solid electrolyte 11 may be less than the median diameter of the active material 10. In this manner, the solid electrolyte 11 and the active material 10 can form a good dispersed state in the electrode 100.

### Active Material

The active material 10 includes a material that can intercalate and deintercalate metal ions (for example, lithium ions).

The active material 10 may contain, for example, a positive electrode active material. Examples of the positive electrode active material that can be used include complex oxides containing transition elements, transition metal fluorides, polyanion materials, fluorinated polyanion materials, transition metal sulfides, transition metal oxysulfides, and transition metal oxynitrides. In particular, when a lithium-containing transition metal oxide is used as the positive electrode active material, the production cost can be decreased, and the average discharge voltage of the battery can be increased.

The active material 10 may contain, for example, a negative electrode active material. Examples of the negative electrode active material that can be used include metal materials, carbon materials, oxides, nitrides, tin compounds, and silicon compounds. The metal material may be an elemental metal. Alternatively, the metal material may be an alloy. Examples of the metal material include lithium metal and lithium alloys. Examples of the carbon material include natural graphite, coke, graphitizing carbon, carbon fibers, spherical carbon, synthetic graphite, and amorphous carbon. From the viewpoint of the capacity density, silicon (Si), tin (Sn), silicon compounds, and tin compounds are desirably used.

The active material 10 may contain a complex oxide containing a transition element. The active material 10 may be a complex oxide containing a transition element. According to this feature, the average discharge voltage of the battery can be increased. The complex oxide containing a transition element selected as the active material 10 may contain Li and at least one element selected from the group consisting of Mn, Co, Ni, and Al. Examples of such a material include Li(NiCoAl)O₂, Li(NiCoMn)O₂, and LiCoO₂.

The active material 10 may contain Li(NiCoAl)O₂. The active material 10 may be Li(NiCoAl)O₂. According to this feature, the energy density of the battery can be further increased. In the description below, “Li(NiCoAl)O₂” may be referred to as “NCA”.

The active material 10 may contain Li(NiCoMn)O₂. The active material 10 may be Li(NiCoMn)O₂. According to this feature, the energy density of the battery can be further increased.

The active material 10 may contain a single active material or multiple active materials having compositions different from one another. According to this feature, the charge capacity of the battery can be improved.

At least part of the active material 10 may be coated with a coating material. According to this feature, the effect of suppressing the interface resistance is obtained, the ion conductivity can be more easily controlled, and thus it becomes possible to design the structure of the electrode 100 for broader ranges. Examples of the coating material that can be used include halide solid electrolytes, sulfide solid electrolytes, oxide materials, oxide solid electrolytes, and carbonates.

The coating layer composed of a coating material may include multiple coating layers. The coating layer may include, for example, a first coating layer that covers at least part of a surface of the active material 10, and a second coating layer that covers at least part of a surface of the active material 10 and the first coating layer. This allows for a wide range of material design such as using a material that exhibits high potential stability in a region in contact with the active material in the coating layer while using a solid electrolyte having high ion conductivity in a region not in contact with the active material in the coating layer, and thus the battery lifetime and the input/output properties are expected to be improved.

Examples of the halide solid electrolytes and the sulfide solid electrolytes that can be used as the coating material are the materials disclosed as examples of the solid electrolyte 11. Examples of the oxide material that can be used include SiO₂, Al₂O₃, TiO₂, B₂O₃, Nb₂O₅, WO₃, and ZrO₂. Examples of the oxide solid electrolyte that can be used include Li—Nb—O compounds such as LiNbO₃, Li—B—O compounds such as LiBO₂ and Li₃BO₃, Li—Al—O compounds such as LiAlO₂, Li—Si—O compounds such as Li₄SiO₄, Li—Ti—O compounds such as Li₂SO₄ and Li₄Ti₅O₁₂, Li—Zr—O compounds such as Li₂ZrO₃, Li—Mo—O compounds such as Li₂MoO₃, Li-V-O compounds such as Li₃V₂O₅, and Li—W—O compounds such as Li₂WO₄. Examples of the carbonate that can be used include lithium carbonate and lithium hydrogen carbonate.

The coating material may contain a halide solid electrolyte. A halide solid electrolyte has high ion conductivity and high high-potential stability. Thus, the use of a halide solid electrolyte as a coating material can further improve the charge/discharge efficiency of the battery.

The coating material may contain Li_{2.7}Ti_{0.3}Al_{0.7}F₆. Li_{2.7}Ti_{0.3}Al_{0.7}F₆ has higher ion conductivity and higher high-potential stability. Thus, the use of Li_{2.7}Ti_{0.3}Al_{0.7}F₆ can further improve the charge/discharge efficiency. In the description below, “Li_{2.7}Ti_{0.3}Al_{0.7}F₆” may be referred to as “LTAF”.

The coating material may contain a sulfide solid electrolyte. A sulfide solid electrolyte has high ion conductivity. Thus, the use of a sulfide solid electrolyte as a coating material can further improve the input/output properties of the battery.

The active material 10 may be a composite active material that includes a halide solid electrolyte that covers at least part of the surface of the active material 10 and a sulfide solid electrolyte that covers at least part of the surface of the active material 10 and the halide solid electrolyte. The active material 10 may be, for example, a composite active material that includes LTAF that covers at least part of the surface of NCA serving as the active material 10 and LiI—LiBr—Li₃PS₄ (LPS) that covers at least part of the surface of the NCA and LTAF.

The use of the composite active material having the aforementioned feature can further improve the charge/discharge capacity, charge/discharge efficiency, and input/output properties of the battery.

The median diameter of the active material 10 may be greater than or equal to 0.01 μm and less than or equal to 100 μm. When the median diameter of the active material 10 is greater than or equal to 0.1 μm, the active material 10 and the solid electrolyte 11 easily form a good dispersed state in the electrode 100. As a result, the charge properties of the battery are improved. When the median diameter of the active material 10 is less than or equal to 100 μm, a sufficient lithium diffusion rate is ensured in the active material 10. Thus, the battery can operate at a high output.

The median diameter of the active material 10 may be greater than the median diameter of the solid electrolyte 11. In this manner, the active material 10 and the solid electrolyte 11 can form a good dispersed state.

As illustrated in FIG. 1, the active material 10, the solid electrolyte 11, and the carbon-based conductive additive 12 in the active material layer 102 may be in contact with one another.

The active material layer 102 may include particles of the active material 10, particles of the solid electrolyte 11, and particles of the carbon-based conductive additive 12.

The active material 10 content and the solid electrolyte 11 content in the active material layer 102 may be the same or different from each other.

### Support

In the example illustrated in FIG. 1, the support 101 is a current collector. However, no limit is imposed on the support 101. The support 101 may be a current collector or an electrolyte layer. The support 101 may be removed after the active material layer 102 is transferred from the support 101 onto a current collector or an electrolyte layer so that the first main surface 102a of the active material layer 102 is in contact with the current collector or the electrolyte layer.

Note that, when manufacturing the battery, the first main surface 102a of the active material layer 102 is desirably located on the current collector side. In other words, the first main surface 102a of the active material layer 102 is desirably in contact with the current collector. According to this feature, the carbon-based conductive additive 12 contained in the active material layer 102 is likely to suppresses the contact between the active material 10 and the current collector. As a result, the contact resistance between the active material 10 and the current collector can be decreased.

The material for the current collector is not particularly limited, and any material that is commonly used in batteries can be used. Examples of the material for the current collector include copper, copper alloys, aluminum, aluminum alloys, stainless steel, nickel, titanium, carbon, lithium, indium, and conductive resins. The shape of the current collector is also not particularly limited. Examples of the shape of the current collector include a foil, a film, and a sheet.

When the support 101 is to be removed after the transfer of the active material layer 102, the material for the support 101 is not particularly limited. The support 101 may be a resin film such as a PET film.

### Method for Producing Electrode

The electrode 100 of the first embodiment can be produced by the following method, for example.

A method for producing the electrode 100 includes applying, to a support 101, an electrode slurry containing an active material 10, a solid electrolyte 11, a carbon-based conductive additive 12, and a solvent to form an active material layer 102. The active material layer 102 has a first main surface 102a not in contact with the support 101 and a second main surface 102b in contact with the support 101. The support 101 may be a current collector. The carbon atom concentration C₁ of a surface layer portion of the active material layer 102 at the first main surface 102a is greater than 29.8 at %. According to this production method, an electrode 100 that can improve the discharge capacity retention rate of the battery can be produced.

FIG. 2 is a flowchart illustrating a method for producing the electrode 100. More specifically, the method for producing the electrode 100 includes preparing an electrode slurry by mixing an active material 10, a solid electrolyte 11, a carbon-based conductive additive 12, and a solvent (step S1) and forming an active material layer 102 by applying the electrode slurry to a support 101 (step S2).

In step S1, a binder may be further added to the electrode slurry. In step S2, the active material layer 102 may be formed by applying the electrode slurry to the support 101 and then drying the applied electrode slurry on a heated hot plate.

The method for controlling the carbon atom concentration C₁ of a surface layer portion of the active material layer 102 at the first main surface 102a is not particularly limited. For example, the carbon atom concentration C₁ can be controlled in step S1. In step S1, a shear force may be added to the electrode slurry for mixing. For example, mixing may be performed by using an automatic mortar, a rotation-revolution mixer, a rotating stirrer-type mixer equipped with a stirring blade, or the like. In addition, in step S1, mixing may be performed by applying ultrasonic waves to the electrode slurry. For example, an ultrasonic homogenizer may be used for mixing. In addition, in step S1, mixing may be performed by applying pressure fluctuations to the electrode slurry. For example, a high-pressure homogenizer may be used for mixing.

The electrode slurry prepared in step S1 contains the active material 10, the solid electrolyte 11, and the carbon-based conductive additive 12 that are forming a good dispersed state. The process time necessary for forming a good dispersed state differs depending on the materials contained in the electrode slurry. Thus, an electrode slurry capable of forming an active material layer 102 that satisfies the desired carbon atom concentration C₁ may be prepared by repeating recovering a fraction of the electrode slurry to prepare an active material layer 102 therefrom and measuring the carbon atom concentration C₁ thereof during step S1.

The method for producing the electrode 100 may further include transferring the active material layer 102 from the support 101 onto a current collector or an electrolyte layer so that the first main surface 102a of the active material layer 102 is in contact with the current collector or the electrolyte layer (step S3).

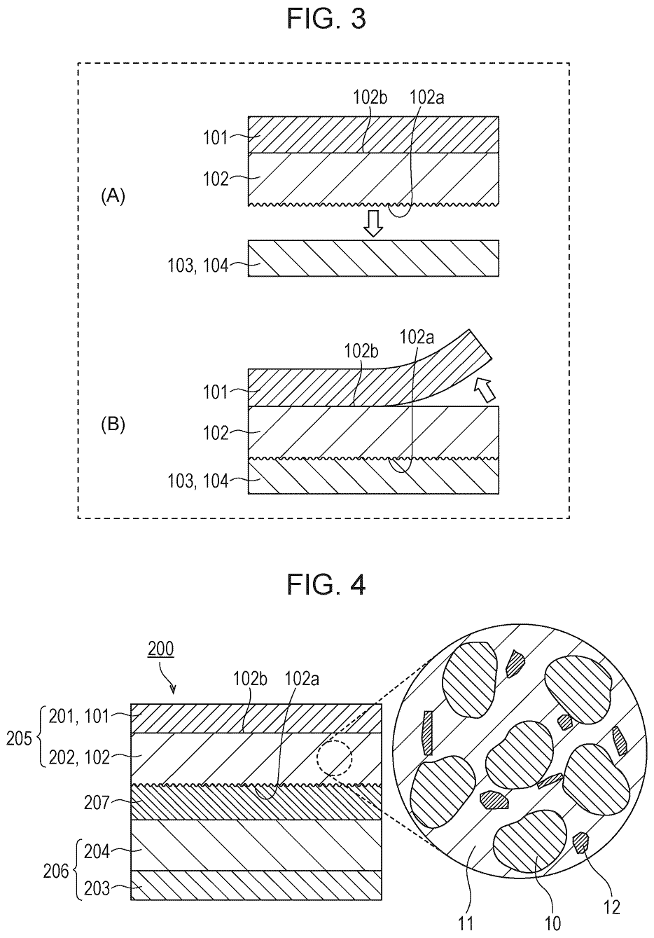

FIG. 3 illustrate step S3. In step S3, first, the active material layer 102 is transferred from the support 101 onto a current collector 103 or an electrolyte layer 104 so that the first main surface 102a of the active material layer 102 is in contact with the current collector 103 or the electrolyte layer 104 (see FIG. 3(a)). After the transfer of the active material layer 102, the support 101 is removed (see FIG. 3(b)). When the active material layer 102 is transferred onto the current collector 103 or the electrolyte layer 104, the first main surface 102a of the active material layer 102 is the surface in contact with the current collector 103 or the electrolyte layer 104. In FIG. 3, the first main surface 102a of the active material layer 102 is indicated by a wavy line to facilitate understanding.

### Second Embodiment

FIG. 4 is a cross-sectional view illustrating a schematic structure of a battery 200 according to a second embodiment.

The battery 200 includes a positive electrode 205, a negative electrode 206, and an electrolyte layer 207 disposed between the positive electrode 205 and the negative electrode 206. At least one selected from the group consisting of a positive electrode 205 and a negative electrode 206 includes the electrode 100 according to the first embodiment. According to this feature, the discharge capacity retention rate of the battery 200 can be improved.

According to this battery 200, the carbon atom concentration C₁ of the surface layer portion of the active material layer 102 at the first main surface 102a is greater than 29.8 at % since at least one selected from the group consisting of the positive electrode 205 and the negative electrode 206 includes the electrode 100 of the first embodiment. Thus, good electron conduction paths can be formed in at least one selected from the group consisting of the positive electrode 205 and the negative electrode 206. As a result, the discharge capacity retention rate of the battery 200 can be improved.

The positive electrode 205 includes a positive electrode current collector 201 and a positive electrode active material layer 202 supported on the positive electrode current collector 201. The negative electrode 206 includes a negative electrode current collector 203 and a negative electrode active material layer 204 supported on the negative electrode current collector 203. The electrolyte layer 207 is disposed between the positive electrode active material layer 202 and the negative electrode active material layer 204.

FIG. 4 illustrates the case in which the positive electrode 205 includes the electrode 100 of the first embodiment. The positive electrode 205 illustrated in FIG. 4 includes a first main surface 102a not in contact with the positive electrode current collector 201 serving as the support 101 and a second main surface 102b in contact with the positive electrode current collector 201. In FIG. 4, the first main surface 102a of the active material layer 102 serving as the positive electrode active material layer 202 is indicated by a wavy line to facilitate understanding. In the example illustrated in FIG. 4, the carbon atom concentration C₁ of a surface layer portion of the positive electrode active material layer 202 at the first main surface 102a is greater than 29.8 at %.

As illustrated in FIG. 4, the positive electrode 205 may include the electrode 100 of the first embodiment. According to this feature, the discharge capacity retention rate of the battery 200 can be improved.

The negative electrode 206 may include the electrode 100 of the first embodiment although this is not illustrated in the drawings. According to this feature, the discharge capacity retention rate of the battery 200 can be improved.

Both the positive electrode 205 and the negative electrode 206 may include the electrode 100 of the first embodiment although this is not illustrated in the drawings. According to this feature, the discharge capacity retention rate of the battery 200 can be further improved.

### Positive Electrode Active Material Layer

The positive electrode active material layer 202 contains, for example, a positive electrode active material. The positive electrode active material contains a material that intercalates and deintercalates metal ions (for example, lithium ions). The positive electrode active material may be any material that has been disclosed as the examples of the active material 10 in the first embodiment.

In order to increase the electron conductivity, the positive electrode active material layer 202 may contain a conductive additive. The conductive additive may be any material that has been disclosed as the examples of the carbon-based conductive additive 12 in the first embodiment. A conductive additive other than the carbon-based conductive additives may be used as the conductive additive.

The positive electrode active material layer 202 may contain a solid electrolyte. According to this feature, the ion conductivity inside the positive electrode active material layer 202 is improved, and thus the battery 200 can operate at a high output. The solid electrolyte may be any material that has been disclosed as the examples of the solid electrolyte 11 in the first embodiment.

Regarding the ratio “v1:100-v1” of the volume (v1) of the positive electrode active material contained in the positive electrode active material layer 202 to the volume (100-v1) of the solid electrolyte contained in the positive electrode active material layer 202, 30≤v1≤95 may be satisfied. When 30≤v1 is satisfied, the energy density of the battery 200 is sufficiently secured. When v1≤95 is satisfied, the battery 200 can operate at a high output.

The weight ratio of the conductive additive contained in the positive electrode active material layer 202 may be greater than or equal to 0.01% and less than or equal to 30%. When the weight ratio of the conductive additive is greater than or equal to 0.01%, the output properties of the battery 200 are sufficiently secured. When the weight ratio of the conductive additive is less than or equal to 30%, the energy density of the battery 200 is sufficiently secured.

The thickness of the positive electrode active material layer 202 may be greater than or equal to 10 μm and less than or equal to 500 μm. When the thickness of the positive electrode active material layer 202 is greater than or equal to 10 μm, the energy density of the battery 200 is sufficiently secured. When the thickness of the positive electrode active material layer 202 is less than or equal to 500 μm, the battery 200 can operate at a high output.

### Negative Electrode Active Material Layer

The negative electrode active material layer 204 contains, for example, a negative electrode active material. The negative electrode active material contains a material that intercalates and deintercalates metal ions (for example, lithium ions). The negative electrode active material may be any material that has been disclosed as the examples of the active material 10 in the first embodiment.

In order to increase the electron conductivity, the negative electrode active material layer 204 may contain a conductive additive. The conductive additive may be any material that has been disclosed as the examples of the carbon-based conductive additive 12 in the first embodiment. A conductive additive other than the carbon-based conductive additives may be used as the conductive additive.

The negative electrode active material layer 204 may contain a solid electrolyte. According to this feature, the ion conductivity inside the negative electrode active material layer 204 is improved, and thus the battery 200 can operate at a high output. The solid electrolyte may be any material that has been disclosed as the examples of the solid electrolyte 11 in the first embodiment.

Regarding the ratio “v2:100-v2” of the volume (v2) of the negative electrode active material contained in the negative electrode active material layer 204 to the volume (100-v2) of the solid electrolyte contained in the negative electrode active material layer 204, 30≤v2≤95 may be satisfied. When 30≤v2 is satisfied, the energy density of the battery 200 is sufficiently secured. When v2≤95 is satisfied, the battery 200 can operate at a high output.

The weight ratio of the conductive additive contained in the negative electrode active material layer 204 may be greater than or equal to 0.01% and less than or equal to 30%. When the weight ratio of the conductive additive is greater than or equal to 0.01%, the output properties of the battery 200 are sufficiently secured. When the weight ratio of the conductive additive is less than or equal to 30%, the energy density of the battery 200 is sufficiently secured.

The thickness of the negative electrode active material layer 204 may be greater than or equal to 10 μm and less than or equal to 500 μm. When the thickness of the negative electrode active material layer 204 is greater than or equal to 10 μm, the energy density of the battery 200 is sufficiently secured. When the thickness of the negative electrode active material layer 204 is less than or equal to 500 μm, the battery 200 can operate at a high output.

### Electrolyte Layer

The electrolyte layer 207 is a layer that contains an electrolyte. The electrolyte is, for example, a solid electrolyte. In other words, the electrolyte layer 207 may be a solid electrolyte layer. The solid electrolyte may be any material that has been disclosed as the examples of the solid electrolyte 11 in the first embodiment.

The thickness of the electrolyte layer 207 may be greater than or equal to 1 μm and less than or equal to 300 μm. When the thickness of the electrolyte layer 207 is greater than or equal to 1 μm, short-circuiting between the positive electrode 205 and the negative electrode 206 rarely occurs. When the thickness of the electrolyte layer 207 is less than or equal to 300 μm, the battery 200 can operate at a high output.

The electrolyte layer 207 may contain two or more solid electrolytes selected from the materials that have been disclosed as the examples of the solid electrolyte 11 in the first embodiment.

At least one selected from the group consisting of the positive electrode active material layer 202, the negative electrode active material layer 204, and the electrolyte layer 207 may contain a binder for the purpose of improving the adhesion between the particles. The binder is used to improve binding properties of the electrode material. Examples of the binder include polyvinylidene fluoride, polytetrafluoroethylene, polyethylene, polypropylene, aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene butadiene rubber, and carboxymethyl cellulose. Alternatively, a styrene-based elastomer may be used as the binder.

Examples of the styrene-based elastomer include styrene-ethylene/butylene-styrene block copolymer (SEBS), styrene-ethylene/propylene-styrene block copolymer (SEPS), styrene-ethylene/ethylene/propylene-styrene block copolymer (SEEPS), styrene-butadiene rubber (SBR), styrene-butadiene-styrene block copolymer (SBS), styrene-isoprene-styrene block copolymer (SIS), and hydrogenated styrene-butadiene rubber (HSBR).

Alternatively, a copolymer of two or more material selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene can be used as the binder.

Alternatively, two or more binders selected from the aforementioned binders may be mixed and used as the binder.

### Current Collector

The materials for the positive electrode current collector 201 and the negative electrode current collector 203 are not particularly limited. Materials commonly used in batteries can be used as the materials for the positive electrode current collector 201 and the negative electrode current collector 203. The materials for the positive electrode current collector 201 and the negative electrode current collector 203 may be materials that have been disclosed as the examples of the current collector in the first embodiment.

The battery 200 of the second embodiment can be configured as a battery of various shapes, such as a coin shape, a cylinder shape, a box shape, a sheet shape, a button shape, a flat shape, and a multilayer shape.

### OTHER EMBODIMENTS

### Appendix

The descriptions of the aforementioned embodiments disclose the following features.

### Feature 1

An electrode including:
a support; and
an active material layer that contains an active material, a solid electrolyte, and a carbon-based conductive additive and that has a first main surface not in contact with the support and a second main surface in contact with the support,
in which a carbon atom concentration of a surface layer portion of the active material layer at the first main surface is greater than 29.8 at %.

According to the electrode of feature 1, the discharge capacity retention rate of the battery can be improved.

### Feature 2

The electrode according to feature 1, in which the solid electrolyte contains at least one selected from the group consisting of a halide solid electrolyte and a sulfide solid electrolyte. According to this feature, the output density of the battery can be improved.

### Feature 3

The electrode according to feature 1 or 2, in which the active material contains a complex oxide containing a transition element. According to this feature, the average discharge voltage of the battery can be improved.

### Feature 4

The electrode according to any one of features 1 to 3, in which the carbon atom concentration is less than or equal to 70.0 at %. According to this feature, the battery can operate at a higher output.

### Feature 5

The electrode according to any one of features 1 to 4, in which the support is a current collector. According to this feature, the discharge capacity retention rate of the battery can be improved.

### Feature 6

A battery including:
a positive electrode;
a negative electrode; and
an electrolyte layer disposed between the positive electrode and the negative electrode,
in which at least one selected from the group consisting of the positive electrode and the negative electrode includes the electrode according to any one of features 1 to 5.

According to the battery of feature 6, the discharge capacity retention rate of the battery can be improved.

### Feature 7

A method for producing an electrode, the method including:
forming an active material layer by applying, to a support, an electrode slurry containing an active material, a solid electrolyte, a carbon-based conductive additive, and a solvent,
in which the active material layer has a first main surface not in contact with the support and a second main surface in contact with the support, and
a carbon atom concentration of a surface layer portion of the active material layer at the first main surface is greater than 29.8 at %.

According to the electrode production method of feature 7, an electrode that can improve the discharge capacity retention rate of the battery can be produced.

### Feature 8

The method for producing an electrode according to feature 7, in which the support is a current collector. According to this feature, an electrode that can improve the discharge capacity retention rate of the battery can be produced.

### Feature 9

The method for producing an electrode according to feature 7 or 8, further including transferring the active material layer from the support onto a current collector or an electrolyte layer so that the first main surface is in contact with the current collector or the electrolyte layer. According to this feature, an electrode that can improve the discharge capacity retention rate of the battery can be produced.

### EXAMPLES

The present disclosure will now be described in detail by referring to Examples and Reference Examples.

### Positive Electrode

Positive electrodes of Examples 1 to 5 and Reference Example 1 were prepared by the following method.

### Example 1

### Composite Active Material

LiF, TiF₄, and AlF₃ were mixed by a mechanochemical milling method to synthesize a fluoride solid electrolyte. The obtained fluoride solid electrolyte had a composition Li_{2.7}Ti_{0.3}Al_{0.7}F₆ (LTAF).

In an argon glove box with a dew point lower than or equal to −60° C., Li₂S and P₂S₅ were weighed into a molar ratio of Li₂S—P₂S₅=75:25. These compounds were ground and mixed in a mortar to obtain a mixture. Then the mixture was subjected to a milling treatment with a planetary ball mill (type P-7 produced by Fritsch Japan Co., Ltd.) for 10 hours under the condition of 510 rpm. As a result, a glassy solid electrolyte was obtained. The glassy solid electrolyte was heat-treated in an inert atmosphere at 270° C. for 2 hours. As a result, a glass ceramic-type sulfide solid electrolyte, Li₂S—P₂S₅ (LPS) was obtained.

Li(NiCoAl)O₂ (NCA) having a median diameter of 5 μm was prepared as a positive electrode active material. NCA and LTAF were mixed so that the ratio thereof on the weight basis was 97.4:2.6 to obtain a mixture. Then the mixture was subjected to a composing treatment by using a particle composing apparatus to prepare a coated active material in which the surface of NCA was coated with LTAF. In the description below, the coated active material in which the surface of NCA is coated with LTAF may be referred to as “LTAF/NCA”. Nobilta NOB-MINI produced by HOSOKAWA MICRON CORPORATION was used as the particle composing apparatus. The operation conditions of the apparatus were as follows.
Electrical power: 12 W per gram of a material
Rotation rate: 6000 rpm
Treatment time: 30 minutes

LPS was dispersed in tetralin (THN) serving as an organic solvent by using a dispersing machine to prepare an LPS dispersion having a solid component ratio of 30%. An ultrasonic homogenizer was used as the dispersing machine. Next, 9000 parts by mass of LTAF/NCA and 275.1 parts by mass of the LPS dispersion were fed to a mixing apparatus. A planetary mixer was used as the mixing apparatus. Mixing and addition of the solvent were alternately repeated in the following order so as to prepare a composite active material in which the surface of LTAF/NCA was coated with LPS. In the description below, the composite active material in which the surface of LTAF/NCA is coated with LPS may be referred to as “LPS/LTAF/NCA”. The aforementioned operations were all performed in an environment in which the dew point temperature was controlled to a temperature lower than or equal to −70° C. The operation conditions of the mixing apparatus were as follows.
(1) Mixing rotation rate: 70 rpm, time: 15 minutes
(2) Addition of solvent THN (34 parts by mass)
(3) Mixing rotation rate: 100 rpm, time: 15 minutes
(4) Addition of solvent THN (30 parts by mass)
(5) Mixing rotation rate: 100 rpm, time: 15 minutes
(6) Addition of solvent THN (23 parts by mass)
(7) Mixing rotation rate: 100 rpm, time: 3 hours

### Binder Solution

In an argon glove box with a dew point lower than or equal to −60° C., a binder A was dissolved in tetralin to prepare a binder solution A having a solid component ratio of 5%. Styrene-butadiene rubber (SBR) was used as the binder A. The viscosity of the prepared binder solution A was measured with a viscometer. HAAKE MARS40 produced by Thermo Fisher Scientific Inc., was used as the viscometer. The viscosity of the binder solution A was 388 mPa·s at a measurement temperature of 25° C. and a shear rate of 40/s.

### Positive Electrode Slurry

LPS/LTAF/NCA was prepared as a positive electrode active material. LPS was prepared as a solid electrolyte. Acetylene black (Li-435 produced by Denka Company Limited, average particle diameter: 23 nm) and vapor-grown carbon fibers (VGCF-H produced by Resonac Holdings Corporation, average fiber diameter: 150 nm, average length: 6 μm) were prepared as the carbon-based conductive additive. In the description below, the acetylene black may be referred to as “AB” and the vapor-grown carbon fibers may be referred to as “VGCF” (registered trademark).

First, in an argon glove box with a dew point lower than or equal to −60° C., a positive electrode active material, a solid electrolyte, a dispersing agent, a binder solution A, and tetralin were mixed to obtain a first liquid mix. The first liquid mix was dispersed for 30 minutes by using an ultrasonic homogenizer to obtain a first dispersion. Next, a carbon-based conductive additive was added to the first dispersion and the resulting mixture was mixed to obtain a second liquid mix. The second liquid mix was dispersed for 50 minutes by using an ultrasonic homogenizer to obtain a positive electrode slurry. In the description below, the time for dispersing the second liquid mix by using the ultrasonic homogenizer is referred to as “second dispersing time”.

The blend ratio of the solid components of the positive electrode slurry was LPS/LTAF/NCA:LPS:dispersing agent:binder A:VGCF:AB=80.7:16.5:0.0740:0.310:2.24:0.221 (mass ratio). The solid component ratio of the positive electrode slurry was 72.0%.

In an argon glove box with a dew point lower than or equal to −60° C., the positive electrode slurry was applied to one surface of an aluminum foil that functioned as a positive electrode current collector and the applied positive electrode slurry was dried for 10 minutes on a hot plate heated to 120° C. Thus, a positive electrode of Example 1 was obtained.

### Example 2

A positive electrode of Example 2 was obtained by the same method as in Example 1 except that the second dispersing time was changed to 30 minutes.

### Example 3

A positive electrode of Example 3 was obtained by the same method as in Example 1 except that the second dispersing time was changed to 20 minutes.

### Example 4

### Binder Solution

In an argon glove box with a dew point lower than or equal to −60° C., a binder B was dissolved in tetralin to prepare a binder solution B having a solid component ratio of 5%. Styrene-butadiene rubber (SBR) having a composition different from that of the binder A was used as the binder B. The viscosity of the prepared binder solution B was measured with a viscometer (HAAKE MARS40 produced by Thermo Fisher Scientific Inc.). The viscosity of the binder solution B was 187 mPa·s at a measurement temperature of 25° C. and a shear rate of 40/s.

A positive electrode of Example 4 was obtained by the same method as in Example 1 except that the binder B was used instead of the binder A and the second dispersing time was changed to 90 minutes.

### Example 5

A positive electrode of Example 5 was obtained by the same method as in Example 4 except that the second dispersing time was changed to 30 minutes.

### Reference Example 1

A positive electrode of Reference Example 1 was obtained by the same method as in Example 4 except that the second dispersing time was changed to 20 minutes.

### Measurement of Carbon Atom Concentration

The carbon atom concentration C₁ of the surface layer portion of the positive electrode active material layer at the first main surface was determined by the following method for each of the positive electrodes of Examples 1 to 5 and Reference Example 1.

First, a positive electrode formed on one surface of an aluminum foil was punched out to prepare a measurement sample. The measurement sample had a first main surface not in contact with the aluminum foil and a second main surface in contact with the aluminum foil. The first main surface of the measurement sample was observed with an SEM (magnification: 1000×), elemental analysis was performed by an EDS, and the carbon atom concentration C was measured at five points in the measurement region. The measured carbon atom concentrations C were averaged to determine the carbon atom concentration C₁.

SU-8230 produced by Hitachi High-Technologies Corporation was used as the SEM. Ultim Extreme produced by Oxford Instruments was used as the EDS. The observation conditions for the SEM were an acceleration voltage of 1 kV and a current value of 10 μA. The measurement conditions for elemental analysis by the EDS were an acceleration voltage of 5 kV and a current value of 10 mA. The area of the region measured by the EDS was 1.2×10⁴ μm². The median diameter of the NCA serving as an active material was 5 μm, and thus, the area A of the region measured by the EDS satisfied A≥(20D)².

Seven major elements including carbon were selected as the elements to be measured by the EDS. Referring to the elements that could be contained in the positive electrode and the major elements confirmed from the EDS spectrum, seven major elements were selected as the major elements to be measured by the EDS. Specifically, sulfur(S), carbon (C), oxygen (O), phosphorus (P), fluorine (F), nickel (Ni), and bromine (Br) were selected as the major elements. The carbon atom concentrations C₁ of the surface layer portion of the positive electrode active material layer at the first main surface in Examples 1 to 5 and Reference Example 1 obtained by the aforementioned method are indicated in Table.

### Negative Electrode

Negative electrodes of Examples 1 to 5 and Reference Example 1 were prepared by the following method.

Li₄Ti₅O₁₂ was prepared as the negative electrode active material. In the description below, “Li₄Ti₅O₁₂” may be referred to as “LTO”. LPS was prepared as a solid electrolyte. VGCF was prepared as a conductive additive. The same binder solution B as in Example 4 was prepared as a binder solution.

First, in an argon glove box with a dew point lower than or equal to −60° C., a negative electrode active material, a solid electrolyte, a dispersing agent, and a binder solution A were mixed to obtain a first liquid mix. The first liquid mix was dispersed for 30 minutes by using an ultrasonic homogenizer to obtain a first dispersion. Next, a conductive additive was added to the first dispersion and the resulting mixture was mixed to obtain a second liquid mix. The second liquid mix was dispersed for 50 minutes by using an ultrasonic homogenizer to obtain a negative electrode slurry.

The blend ratio of the solid components of the negative electrode slurry was LTO/dispersing agent/LPS/VGCF/binder A=100/1.88/33.6/1.1/0.86 (mass ratio). The solid component ratio of the slurry was 56.0%.

In an argon glove box with a dew point lower than or equal to −60° C., the negative electrode slurry was applied to one surface of an aluminum foil that functioned as a negative electrode current collector and the applied negative electrode slurry was dried for 10 minutes on a hot plate heated to 120° C. Thus, a negative electrode was obtained.

For the negative electrodes of Examples 1 to 5 and Reference Example 1, the coating weight of the negative electrode active material layer prepared on one surface of the aluminum foil was adjusted as follows. The charge capacity per unit area of the negative electrode active material layer prepared on one surface of the aluminum foil was adjusted to be 1.1 relative to the charge capacity per unit area of the positive electrode active material layer prepared on one surface of the aluminum foil. Here, a value (theoretical capacity) of 210 mAh/g was used as the charge capacity per unit mass of the positive electrode active material. Furthermore, a value (theoretical capacity) of 175 mAh/g was used as the charge capacity per unit mass of the negative electrode active material.

### Electrolyte Layer

Electrolyte layers of Examples 1 to 5 and Reference Example 1 were prepared by the following method.

LPS was prepared as a solid electrolyte. The same binder solution B as in Example 4 was prepared as a binder solution.

First, in an argon glove box with a dew point lower than or equal to −60° C., a solid electrolyte, a dispersing agent, and a binder solution A were mixed to obtain a liquid mix. The liquid mix was dispersed in tetralin by using an ultrasonic homogenizer to obtain a solid electrolyte slurry.

In an argon glove box with a dew point lower than or equal to −60° C., the solid electrolyte slurry was applied to one surface of an aluminum foil and the applied solid electrolyte slurry was dried for 10 minutes on a hot plate heated to 120° C. Thus, an electrolyte layer was obtained.

### Negative Electrode Counter Electrode

Negative electrode counter electrodes of Examples 1 to 5 and Reference Example 1 were prepared by the following method.

An electrolyte layer was stacked on the negative electrode so that the electrolyte layer formed on one surface of the metal foil and the negative electrode formed on one surface of the aluminum foil opposed each other so as to obtain a multilayer body. The multilayer body was pressed by a flat-plate hot press machine heated to 120° C. After the thermal pressing, the metal foil was removed from the electrolyte layer. Thus, a negative electrode counter electrode in which the electrolyte layer, the negative electrode, and the aluminum foil were laminated in this order was obtained.

### Battery

Batteries of Examples 1 to 5 and Reference Example 1 were prepared by the following method.

First, in a die, the positive electrode was stacked on the negative electrode counter electrode so that the positive electrode formed on one surface of the aluminum foil and electrolyte layer of the negative electrode counter electrode opposed each other so as to obtain a multilayer body. The multilayer body was pressed by a flat-plate hot press machine heated to 120° C. Thus, a power generation element in which the aluminum foil, the positive electrode, the electrolyte layer, the negative electrode, and the aluminum foil were stacked in this order was obtained.

Next, a current collecting lead was attached to each of the aluminum foils by using a carbon tape. Lastly, the power generation element was isolated from the ambient atmosphere by using an aluminum laminate film to obtain a battery.

The current collecting leads attached to the aluminum foils extended from the space in which the power generation element was hermetically sealed with the aluminum laminate film to the outside where no such seal was provided. For the charge and discharge measurement, the current collecting leads were attached so that the power generation element was electrically connected to the measurement device via the current collecting leads. Furthermore, the current collecting leads were not electrically in contact with the aluminum vapor deposited film contained in the aluminum laminate film.

### Charge/Discharge Test

The charge/discharge test was performed under the following conditions by using the batteries of Examples 1 to 5 and Reference Example 1.

The battery was placed in a constant-temperature vessel at 25° C.

Constant-current charging was performed at a current value of 0.68 mA equivalent to the 0.333 C rate (3 hour rate) with respect to the theoretical capacity of the battery, and the charging was ended when the voltage reached 2.7 V.

Next, constant-voltage charging was performed at a voltage of 2.7 V, and the charging was ended when the current value was below 20 μA equivalent to the 0.01 C rate.

After an interval of 10 minutes, constant-current discharging was performed as before at a current value of 0.68 mA equivalent to the 0.333 C rate (3 hour rate) with respect to the theoretical capacity of the battery, and the discharging was ended when the voltage reached 1.5 V.

Next, constant-voltage discharging was performed at a voltage of 1.5 V, and the discharging was ended when the current value was below 20 μA equivalent to the 0.01 C rate.

The charge/discharge test was performed for a total of two times by the same method as described above, and the discharge capacity C_{0.333} observed when the constant-current discharging was performed at a 0.333 C rate during the second charge/discharge test was measured.

Next, constant-current charging was performed at a current value of 0.68 mA equivalent to the 0.333 C rate (3 hour rate) with respect to the theoretical capacity of the battery, and the charging was ended when the voltage reached 2.7 V.

Next, constant-voltage charging was performed at a voltage of 2.7 V, and the charging was ended when the current value was below 20 μA equivalent to the 0.01 C rate.

After an interval of 10 minutes, constant-current discharging was performed at a current value of 40 mA equivalent to the 20 C rate with respect to the theoretical capacity of the battery, and the discharging was ended when the voltage reached 1.5 V.

Next, constant-voltage discharging was performed at a voltage of 1.5 V, and the discharging was ended when the current value was below 20 μA equivalent to the 0.01 C rate.

The discharge capacity C₂₀ observed when the constant-current discharging was performed at a 20 C rate was measured.

The ratio determined by “a value (C₂₀/C_{0.333}) (obtained by dividing the discharge capacity C₂₀ by the discharge capacity C_{0.333})×100” was assumed to be the discharge capacity retention rate (%). The results are indicated in Table.

TABLE

| | Positive electrode | | | Battery |
|---|---|---|---|---|
| | | Second | | Discharge |
| | | dispersing | Carbon atom | capacity |
| | | time | concentration C₁ | retention |
| | Binder | (min) | (at %) | rate (%) |
| Example 1 | A (solution | 50 | 45.5 | 76.9 |
| | viscosity: | | | |
| | 388 mPa · s) | | | |
| Example 2 | A (solution | 30 | 44.8 | 76.5 |
| | viscosity: | | | |
| | 388 mPa · s) | | | |
| Example 3 | A (solution | 20 | 42.3 | 71.2 |
| | viscosity: | | | |
| | 388 mPa · s) | | | |
| Example 4 | B (solution | 90 | 32.9 | 70.8 |
| | viscosity: | | | |
| | 187 mPa · s) | | | |
| Example 5 | B (solution | 30 | 30.6 | 70.6 |
| | viscosity: | | | |
| | 187 mPa · s) | | | |
| Reference | B (solution | 20 | 29.8 | 70.3 |
| Example 1 | viscosity: | | | |
| | 187 mPa · s) | | | |

### Discussions

As indicated in Table, the carbon atom concentration C₁ of the surface layer portion of the positive electrode active material layer at the first main surface was greater than 29.8 at % in Examples 1 to 5. Meanwhile, the carbon atom concentration C₁ of the surface layer portion of the positive electrode active material layer at the first main surface was 29.8 at % in Reference Example 1. Comparing Examples 4 and 5 and Reference Example 1 presumably reveals that aggregates of the carbon-based conductive additive formed easily in the positive electrode of Reference Example 1 since the second dispersing time was shorter than that in Examples 4 and 5, and since the aggregates had settled down toward the aluminum foil, the carbon atom concentration C₁ decreased. Moreover, although the second dispersing time was 20 minutes in both Example 3 and Reference Example 1, the carbon atom concentration C₁ in Reference Example 1 was smaller than the carbon atom concentration C₁ in Example 3. This is presumably because the viscosity of the binder solution B was smaller than the viscosity of the binder solution A, specifically, one half or less of the viscosity of the binder solution A, and thus aggregates of the carbon-based conductive additive formed easily and had settled down toward the aluminum foil, thereby decreasing the carbon atom concentration C₁. The discharge capacity retention rate of the batteries improved by using the positive electrodes of Examples 1 to 5.

Note that although the electrode of the present disclosure was used as the positive electrode in the aforementioned examples, the same effects are expected even when the electrode of the present disclosure is used as a negative electrode.

As such, according to the present disclosure, an electrode suitable for improving the discharge capacity retention rate of the battery can be provided.

The electrode of the present disclosure can be used in, for example, a battery (for example, an all-solid-state lithium ion secondary battery).

What is claimed is:

1. An electrode comprising:
a support; and
an active material layer that contains an active material, a solid electrolyte, and a carbon-based conductive additive and that has a first main surface not in contact with the support and a second main surface in contact with the support,
wherein a carbon atom concentration of a surface layer portion of the active material layer at the first main surface is greater than 29.8 at %.

2. The electrode according to claim 1, wherein the solid electrolyte contains at least one selected from the group consisting of a halide solid electrolyte and a sulfide solid electrolyte.

3. The electrode according to claim 1, wherein the active material contains a complex oxide containing a transition element.

4. The electrode according to claim 1, wherein the carbon atom concentration is less than or equal to 70.0 at %.

5. The electrode according to claim 1, wherein the support is a current collector.

6. A battery comprising:
a positive electrode;
a negative electrode; and
an electrolyte layer disposed between the positive electrode and the negative electrode,
wherein at least one selected from the group consisting of the positive electrode and the negative electrode includes the electrode according to claim 1.

7. A method for producing an electrode, the method comprising:
forming an active material layer by applying, to a support, an electrode slurry containing an active material, a solid electrolyte, a carbon-based conductive additive, and a solvent,
wherein the active material layer has a first main surface not in contact with the support and a second main surface in contact with the support, and
a carbon atom concentration of a surface layer portion of the active material layer at the first main surface is greater than 29.8 at %.

8. The method for producing an electrode according to claim 7, wherein the support is a current collector.

9. The method for producing an electrode according to claim 7, further comprising transferring the active material layer from the support onto a current collector or an electrolyte layer so that the first main surface is in contact with the current collector or the electrolyte layer.
